(19) United States
(12) Patent Application Publication
(10) Pub. No.: US 2024/0037465 A1
(43) Pub. Date: Feb. 1, 2024

(54) PROFICIENCY PROFILE MANAGEMENT AND RECOMMENDATION SYSTEM

(71) Applicant: McGraw Hill LLC, New York, NY (US)

(72) Inventors: Anna Jozina Verhagen, Belmont, CA (US); Dylan Arena, Redwood City, CA (US); David Hatfield, Mountain View, CA (US)

(21) Appl. No.: 18/227,204

(22) Filed: Jul. 27, 2023

Related U.S. Application Data
(60) Provisional application No. 63/393,510, filed on Jul. 29, 2022.

(51) Int. Cl. G06Q 10/0631; H04L 67/30

(52) U.S. Cl. CPC G06Q 10/063112; H04L 67/30

(57) ABSTRACT

A system and method to generate a first skill-mapped item based on a mapping of at least a portion of first data associated with a first instructional product to a first skill in an ontology. A second skill-mapped item is generated based on a mapping of at least a portion of second data associated with a second instructional product to the first skill in the ontology. Based on first performance data associated with the first instructional product, a first estimate of skill proficiency corresponding to the first skill-mapped item and the first instructional product is determined. Based on second performance data associated with the second instructional product, a second estimate of skill proficiency corresponding to the second skill-mapped item and the second instructional product is determined. Based on the first estimate of skill proficiency and the second estimate of skill proficiency, a combined estimate of skill proficiency relating to the first skill is generated. A universal profile including the combined estimate of skill proficiency relating to at least the first skill is generated and displayed.

### CROSS-REFERENCE TO RELATED APPLICATION

This application claims the benefit of U.S. Provisional Patent Application No. 63/393,510 filed on Jul. 29, 2022, the entirety of which is incorporated herein by this reference.

### TECHNICAL FIELD

The disclosure relates generally to a digital learning platform, and more particularly to proficiency profile generation based on data associated with multiple independent educational products or systems, as well as recommendation of educational experiences across those products.

### BACKGROUND

Many available digital learning products fail to provide comprehensive management of student proficiencies. These products are based on information for estimating student proficiency with targeted skills that has a single source and context. In particular, each product limits the analysis of student proficiencies based on only the data derived via that product. Accordingly, this type of product can report how well a student is demonstrating a particular skill as determined by a limited set of data. Educators using such products are not provided with a comprehensive understanding of how well a student is demonstrating that skill across a variety of learning products.

Furthermore, all instructional recommendations based on student skill proficiency are only in the context of that product. Recommending a specific next step in a product is helpful, but educators are not provided with a recommended next step that applies across a variety of learning products.

Other proficiency assessment systems have attempted to estimate proficiency along a “universal” unidimensional scale separately for each participating product. In addition to resulting in potentially conflicting “universal” estimates for the same student at the same moment in time, this approach leads to recommendations based on a score that is designed to capture at a high level approximately where a student falls along a unidimensional progression, without providing any detailed information about which specific skills a student is struggling with. For example, a student may receive a high unidimensional scaled score because the student is generally good at numbers and operations, even though the student missed several months of school during which geometry concepts were taught. According to the unidimensional scaled score, a false indication is generated that the student possesses knowledge of the geometry concepts because of where those concepts fall in the unidimensional progression.

### BRIEF DESCRIPTION OF THE DRAWINGS

The present disclosure is illustrated by way of example, and not by way of limitation, and can be more fully understood with reference to the following detailed description when considered in connection with the figures as described below.

FIG. 1 illustrates an example proficiency profile management and recommendation system in accordance with one or more embodiments of the present disclosure.

FIG. 2 illustrates an example graph corresponding to the generation of updated universal skill mastery estimates for a skill based on evidence for mastery from the different products at time points weighted by a function of the time that has passed since a student worked in those products and the strength of signals coming from each product, in accordance with one or more embodiments of the present disclosure.

FIG. 3 illustrates an example graph including proficiency estimates associated with standards and skills corresponding to an ontology, in accordance with one or more embodiments of the present disclosure.

FIG. 4 illustrates a process flow diagram relating to an example method for generating and displaying a universal profile including a combined estimate of skill proficiency based on data from multiple instructional products, in accordance with one or more embodiments of the present disclosure.

FIG. 5 illustrates an example computer system operating in accordance with some implementations.

### DETAILED DESCRIPTION

Aspects of the present disclosure are directed to a system (herein referred to as a “proficiency profile and recommendation system”) to execute one or more methods or processes to generate proficiency estimates and a proficiency profile for students based on data associated with multiple different source products. According to embodiments, the proficiency profile and recommendation system defines an ontology of skills across grade levels in an academic discipline. The proficiency profile and recommendation system maps assessment items (e.g., in tests, quizzes, assignments, observations, etc.) from two or more different instructional products (e.g., a basal-curriculum mathematics program, a math intervention program, and a supplemental math practice program) to the skills in the defined ontology.

Advantageously, multiple different instructional products can serve as sources of data for each student. By focusing on estimating universal proficiency at the skill level based on data from different products, the proficiency profile and recommendation system yields a granular profile of student strengths and weaknesses that leads to more precise and accurate recommendations for how best to support that student across a variety of different products and contexts. For example, the proficiency profile and recommendation system generates a skill-based proficiency profile configured to capture the specific gaps in a student's knowledge of a particular topic or subject (e.g., a student's knowledge of particular subject such as geometry). The proficiency and recommendation system of the present application provides needed support for a mastery-based instructional paradigm, which education researchers acknowledge as desirable for optimizing learning.

In an embodiment, for each instructional product of the set of source instructional products (also referred to as “products”, “source products”, or a “product platform”), the proficiency profile and recommendation system collects student performance data for one or more of the skill-mapped assessment items. In an embodiment, for each source product, the proficiency profile and recommendation system uses the collected performance data to generate estimates of skill proficiency corresponding to the respective source product.

In an embodiment, for each mapped skill, the proficiency profile and recommendation system collects the product-specific skill proficiency estimates and combines them to generate a product-agnostic “universal” skill proficiency estimate. In an embodiment, the proficiency profile and recommendation system combines the universal skill proficiency estimates into a longitudinal mastery-based proficiency profile spanning all measured skills, as well as a single unidimensional-scale estimate representing overall proficiency in the discipline (e.g., overall proficiency in mathematics). According to embodiments, the generated multi-source proficiency profile can be used to characterize a student's current proficiency and performance across multiple instructional products, generate recommendations of optimally challenging skill-mapped assignments across instructional products to support current skill levels, monitor growth over time (and compare growth rates among students), and predict future performance.

The proficiency profile and recommendation system implements an improved approach to the problems and deficiencies of typical proficiency estimation approaches by generating estimates based on combining data from across different products at the level of individual skills. Furthermore, the proficiency profile and recommendation system of the present disclosure uses skill-level estimates to provide a single unidimensional-scale proficiency estimate that reflects data from a set of instructional products. Advantageously, the operations performed by the proficiency profile and recommendation system yield accurate “universal” estimates, both at the level of discrete skills and at the level of overall proficiency in a discipline (e.g., mathematics). In addition, the proficiency profile and recommendation system generates optimized recommendations relating to one or more next instructional steps across the set of different learning products.

In an embodiment, the proficiency profile and recommendation system can use the universal proficiency profile associated with a student (e.g., Student A) to generate one or more recommendations relating to assets associated with multiple different instructional products. For example, the proficiency profile and recommendation system can generate a blended recommendation including a first recommended asset from Product Platform 1 (e.g., an instructional video from Product Platform 1) and a second recommended asset from Platform 2 (e.g., a problem set from Product Platform 2), where Product Platform 1 and Product Platform 2 are two independent learning products developed and administered by different companies that address one or more overlapping skills.

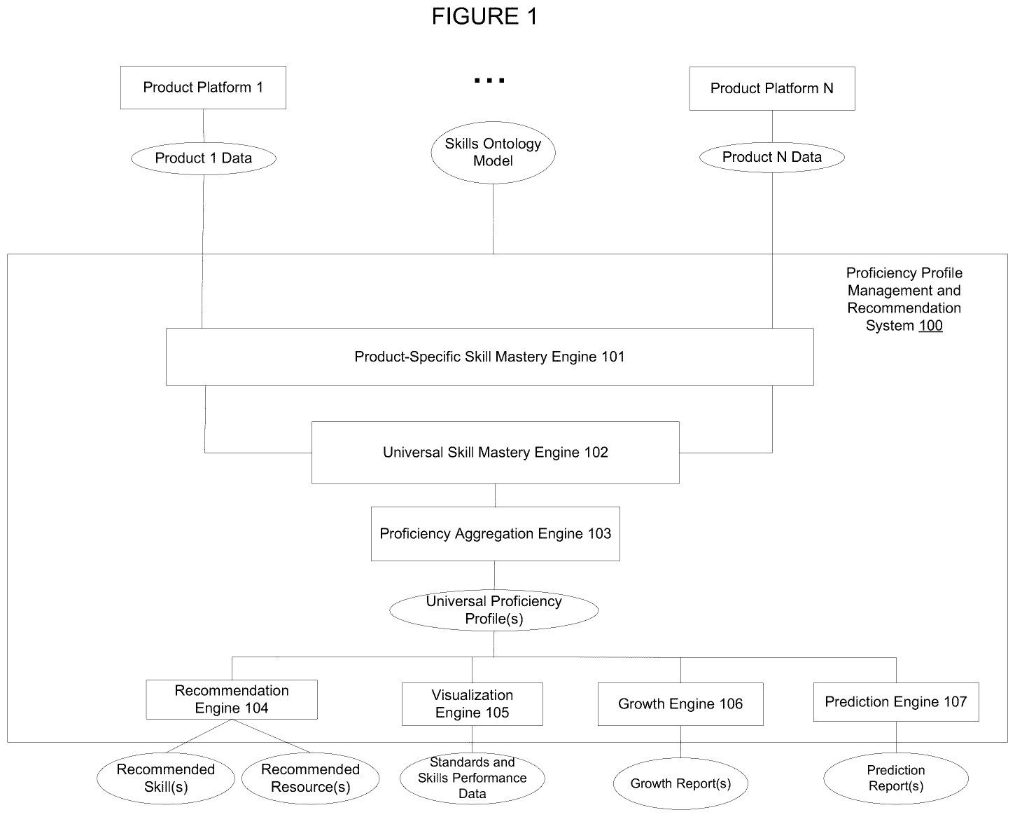

FIG. 1 illustrates an example multi-source proficiency profile management and recommendation system 100 (also referred to as the “proficiency profile management and recommendation system 100”), according to embodiments of the present disclosure. The proficiency profile management and recommendation system 100 is a computing system communicatively connected to multiple different instructional products (e.g., Product Platform 1 . . . Product Platform N, where N is any natural number) via a suitable communication network. In an embodiment, the proficiency profile management and recommendation system 100 may be accessible and executable on one or more separate computing devices (e.g., servers). In an embodiment, the proficiency profile management and recommendation system 100 may be communicatively coupled to the instructional products via any suitable interface or protocol, such as, for example, application programming interfaces (APIs), a web browser, JavaScript, etc. In an embodiment, the proficiency profile management and recommendation system 100 is communicatively coupled to each instructional product via an API. In an embodiment, communications between the proficiency profile management and recommendation system 100 and each instructional product can be managed by an API. In an embodiment, the proficiency profile management and recommendation system 100 includes one or more memory devices to store instructions executable by one or more processing devices to perform the instructions to execute the operations, features, and functionality described in detail herein. In an embodiment, the proficiency profile management and recommendation system 100 can be accessible by one or more users (e.g., educators, students, parents, etc.) to view one or more interfaces generated by the proficiency profile management and recommendation system 100.

In an embodiment, the proficiency profile management and recommendation system 100 can include one or more software modules executable by one or more computer platforms that are interconnected by one or more communication channels or networks, which may include the Internet. The software modules may be, for example, a hardware component, circuitry, dedicated logic, programmable logic, microcode, etc., that may be implemented by a processing device executing instructions stored by the memory of the proficiency profile management and recommendation system 100.

As shown in FIG. 1, according to embodiments, the proficiency profile management and recommendation system 100 includes a product-specific skill mastery engine 101, a universal skill mastery engine 102, a proficiency aggregation engine 103, a recommendation engine 104, a visualization engine 105, a growth engine 106, and a prediction engine 107. According to embodiments, the example modules or engines are configured to perform operations, processes, steps, etc. to enable the functionality, as described in detail herein.

As shown in FIG. 1, the proficiency profile management and recommendation system 100 uses a skills ontology defined by experts (e.g., learning scientists, psychometricians, and subject-matter experts in the discipline). In an embodiment, the proficiency profile management and recommendation system 100 is a mastery-based system, where each skill is defined at a granular level to support binary measurements of mastery or non-mastery. In an embodiment, each skill in the ontology belongs to an educational standard (e.g., as determined by a state or similar regulatory body), allowing measurements of skill proficiencies to inform estimates of proficiency with standards. Similarly, in an embodiment, skills are connected to each other directly or indirectly in progressions, allowing (a) measurements of specific skills to inform estimates of related skills earlier or later in a skills progression and (b) recommendations of optimally challenging instructional content based on progress along a skills progression. As shown, the skills ontology provides a structure or definition that can be used to map assessment items from two or more different instructional products (e.g., Product Platform 1, . . . , Product Platform N) to the skills in the skills ontology.

In an embodiment, the product-specific skill mastery engine 101 processes data from the respective product platforms (e.g., product 1 data from Product Platform 1 and product N data from Product Platform N). For example, the product data can include evidence from student performance on assessment items related to a particular skill (i.e., student response data) and provide a skill proficiency estimate for that skill that reflects the probability that a student has mastered that skill.

According to embodiments, each product platform represents a different learning context and environment, and as such, provides product data that is different. For example, a portion of product data about correct and incorrect responses from one product platform (e.g., Product Platform 1) can give different signals about student proficiency as compared to similar data received from another product (e.g., Product Platform N). According to embodiments, many factors can influence what inferences are supported by a student's correct or incorrect answer to a question, such as, for example, whether the assessment/assignment in which the question appears is adaptive, what the assessment/assignment's goal is, whether all or only some students receive that assessment/assignment, what forms of encouragement the student receives to try hard on their first attempt, etc.

According to embodiments, the product-specific skill mastery engine 101 is configured to apply product-specific rules, statistical models, and machine learning validation tools to create product-specific model pipelines that produce skill probability-of-mastery estimates on a per-product basis that enable meaningful comparison across multiple different products.

According to embodiments, given a skills ontology, the product-specific skill mastery engine 101 generates a mapping between questions in each product with skills from that skills ontology. In an embodiment, the skills can be defined at a level of granularity such that a student either has or has not mastered a skill at any given point in time.

For example, when a student answers questions in a first product related to a first skill, the product-specific skill mastery engine 101 estimates whether a student has mastered the skill or not, which is reflected in a probability of mastery. For example, the product-specific skill mastery engine 101 may generate the probability of mastery and compare it to various thresholds for different levels of confidence about mastery (e.g., the farther the probability is away from 0.5, the more certain the product-specific skill mastery engine 101 is about a student's mastery or non-mastery of a skill).

According to embodiments, the product-specific skill mastery engine 101 can employ a skill-based mastery model to infer the mastery probability based on the evidence for mastery provided by answers to questions related to a skill. In embodiments, the amount or level of evidence a correct or incorrect answer to a question provides for mastery can differ depending on the context in which those answers were given. For example, the product-specific skill mastery engine 101 can assign a correct open-ended question a stronger level of evidence for skill mastery as compared to a correct answer to a multiple-choice question. In an embodiment, the product-specific skill mastery engine 101 can take into account other factors associated with the product data. For example, the product-specific skill mastery engine 101 can determine a question that was answered incorrectly within 0.2 seconds of the student seeing the question provides less evidence for non-mastery than a question that was answered incorrectly after a longer period of time. According to embodiments, the product-specific skill mastery engine 101 employs skill-based mastery models that take this type of contextual information into account by incorporating model parameters reflecting that information.

According to embodiments, the product-specific skill mastery engine 101 can employ one or more of several classes of psychometrics models to quantify the evidence for skill mastery provided by responses to questions in the context of a product (e.g., Diagnostic Classification Models (DCM) or Cognitive Diagnosis Models (CDM)). In an embodiment, the evidence for skill mastery can be represented by the likelihood of the observed data V A for a student given their mastery profile for a set of K skills m=m₁, . . . , m_{K}, P(Y_{A}|m).

In an embodiment, the product-specific skill mastery engine 101 can execute a Deterministic Inputs, Noisy “And” gate model (DINA) model to determine a mastery relative to a single skill. In this example, the likelihood of response Yᵢ to a question i in product A given mastery mₖ of skill k is conditional on guess and slip parameters (g and s) associated with a particular question i, as represented by the following equation:

P(yᵢ|g,s,mₖ)=[(1−s)^{Y}^{ᵢ}(s)^{(1-Y}^{ᵢ}⁾]^{m}^{ₖ}[g(1−g)^{1-Y}^{ᵢ}]^{1-m}^{ₖ}

According to embodiments, the product-specific skill mastery engine 101 processes multiple skills for each product platform, since most products measure more than one skill. Sometimes, multiple skills can be measured in a single question. In an embodiment, the DINA model is configured to assume all skills related to a question need to be mastered to answer the question correctly. In this case, m k in the equation above is replaced with the product of the subset of the skills profile m=m₁, . . . , m_{K} that includes only those skills related to that question, resulting in a “1” if all skills related to the question have been mastered or a “0” if not.

In an embodiment, the product-specific skill mastery engine 101 uses a Bayesian framework to update the mastery probability for a student on skill m k after collecting answers to questions Y_{A} from product A. Model parameters (such as the guess and slip parameters g and s) are pre-calibrated/pre-trained and fixed at the moment of inference. The update combines the prior mastery probability P(mₖ=1) with the likelihood of the data Y_{A} given mastery of skill k, P(Y_{A}|mₖ=1) to result in a probability of mastery of skill k given the data in a product P(mₖ=1|Y_{A}).

In an embodiment, the product-specific skill mastery engine 101 can be initialized by collecting a representative sample of student responses to all questions mapped to a particular skill. For each such mapped question, the initialization process determines the characteristics that contribute to the strength of the question's signals about proficiency: relative difficulty, question type (e.g., multiple-choice or open-ended), assessment type (e.g., low-stakes practice assignment with multiple tries or high-stakes assessment), etc.

In an embodiment, the product-specific skill mastery engine 101 estimates model parameters corresponding to the above characteristics by evaluating the collected student responses to that question. According to embodiments, the process of defining and training a model for a specific product includes: (a) determining relevant characteristics of the assessment/assignment environment (e.g., high vs. low stakes, student behavioral characteristics) and questions (e.g., multiple choice vs. open-ended), based on a combination of expert and product knowledge and statistical analysis of data from a representative student sample and (b) defining model parameters reflecting those characteristics. According to embodiments, the process of defining and training a model for a specific product includes training/calibrating the model parameters based on a representative set of student responses to the questions in the product and validating the results with representative samples of data from the same product, from other products, and from external (benchmark) tests.

Because the metric of interest is the mastery probability for a skill, the results of skill-based mastery models for different products are pragmatically comparable, even though models for those different products are defined and trained independently (unlike, e.g., IRT scaled scores). The product-specific skill mastery probabilities form the basis for the universal skill mastery probabilities.

In an embodiment, the universal skill mastery engine 102 takes the skill proficiency estimates produced by the product-specific skill mastery engine 101 using data from multiple individual sources/products for a particular skill and provides an overall or “universal” skill proficiency estimate for that skill that reflects the probability that a student has reached a threshold level with respect to that skill (i.e., demonstrated a “mastery” of the skill).

According to embodiments, because the product-specific skill mastery probabilities are generated for the same student at different points in time, the universal skill mastery engine 102 considers the time between observations and the strength of evidence coming from different products when combining those mastery probabilities to generate the one universal skill mastery probability.

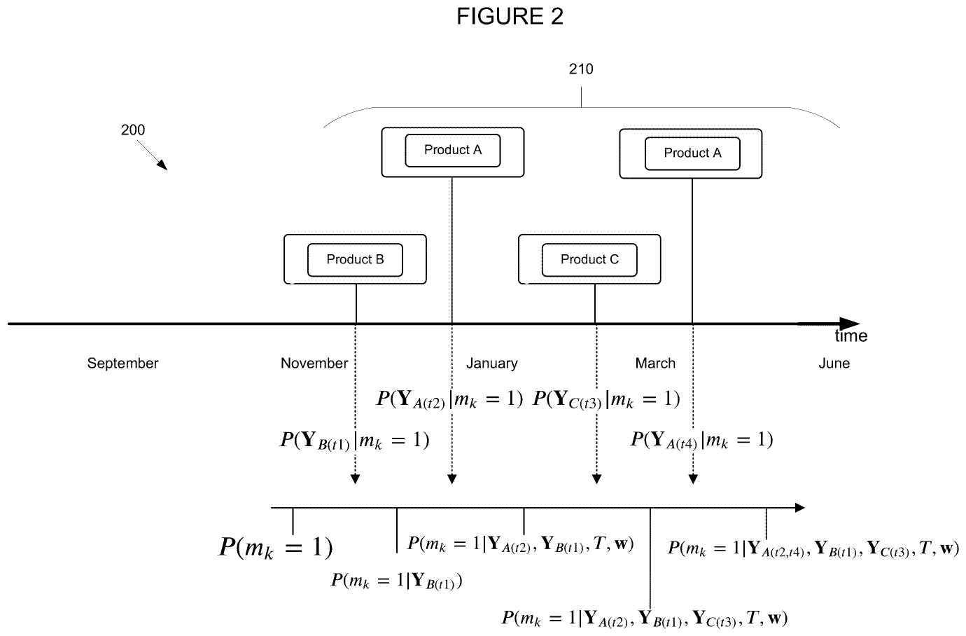

As shown in the graph 200 of FIG. 2, in an embodiment, the universal skill mastery engine 102 may employ a Bayesian framework to update universal skill mastery estimates for a skill k based on evidence for mastery from the different products at time points t, represented by the likelihood P(Y₍ₜ₎|mₖ=1), weighted by a function of the time that has passed since a student worked in those products (T) as well as the strength of the signals coming from each product (w).

As illustrated in FIG. 2, as time goes on, an exponential function of T decreases the weight of previous observations. Weights w representing the strength of the signals from the set of products 210 (e.g., Product A, Product B, Product C) can be based on one or more of the reliability, validity, and consistency of the proficiency scores generated by the products, incorporating the product's general signal quality (e.g., based on an estimate using any reasonable convergent-validity approach) and student-specific signal strength (e.g., based on the number and recency of student responses to questions in that product).

According to embodiments, the universal skill mastery engine 102 is initialized by collecting a representative sample of students' product-specific proficiency estimates for a particular skill from all relevant products. The initialization process uses the collected data for calibration/research/convergent-validity estimates—i.e., to generate rules and weights for combining proficiency estimates across products.

With reference to FIG. 1, according to embodiments, the proficiency aggregation engine 103 identifies skill proficiencies across multiple skills and uses the skills ontology as well as empirical data about the relationships between skills to create a weighted aggregate of these skills for summarizing proficiency at the standard, domain, or discipline level. In an embodiment, the proficiency aggregation engine 103 determines one or more of hierarchical, sequential, and relative-difficulty relationships between skills based on theory and empirical evidence from student data within and across products. Based on those relationships, the proficiency aggregation engine 103 estimates the aggregate (i.e., less-granular) proficiency as a weighted combination of the more-granular proficiency estimates. For aggregations at the level of the standard, these will be the skill-based estimates from the universal skill mastery engine 102. For aggregations at the domain or discipline levels, these more-granular estimates will be results from a previous aggregation step of the proficiency aggregation engine 103 itself. In an embodiment, if additional information exists for a student at a higher level of aggregation (e.g., discipline or domain scores from standardized benchmark assessments), this information can be used to strengthen or diversify the aggregate proficiency estimate.

According to embodiments, the proficiency aggregation engine 103 can employ one or more Bayesian approaches to aggregate skill-level mastery probability estimates. In each approach, the proficiency for the higher-order or aggregate construct is conditional upon the mastery profile m=m₁, . . . , m_{K} for a set of K lower-level skills. According to embodiments, an approach can be selected based on assumptions about the relationships between the lower-order and higher-order constructs at hand.

For example, when lower-order skills whose proficiency is defined as binary (e.g., mastered or not) are assumed to vary in difficulty along a continuous higher-order scale, a higher-order latent trait model can be used. This type of model is conceptually similar to an item response theory (IRT) model, with skill-level difficulty parameters instead of item-level difficulty parameters. Assuming a vector b of fixed and calibrated/trained parameters for the skill difficulties, the joint distribution for student ability on the continuous scale θ and the mastery profile vector m=m₁, . . . , m_{K} can be derived according to the following expression:

P(θ,min|Y)∝P(Y|m)P(m|θ,b)P(θ)

where skill-specific mastery, represented by the likelihood P(Y|m), is combined with the probability of the mastery profile m=m₁, . . . , m_{K} given values of the latent trait θ and fixed skill difficulties b, P(m|θ,b).

In an embodiment, if the lower- and higher-order constructs are both assumed to be binary, a model of the probability of mastery for the higher-order skill conditional on mastery of the lower-order skills can be used, which represents assumptions of sequential, hierarchical, and/or relative-difficulty relationships between lower-order and higher-order skills. According to embodiments, those relationships can differ per specific set of skills. For example, the skills can build upon each other sequentially towards mastery of a higher-order skill. In another example, mastery of the higher-order skill requires mastery of a set of complementary, but non-sequential skills. Examples of such models include, but are not limited to, a sequential higher-order latent structural model or a latent conjunctive Bayesian network.

In an embodiment, let the vector o represent the mastery profile for the higher-order skills, and P(m|o) the conditional probabilities of having mastered the lower-order skills given mastery of the higher-order skills, based on the sequential, hierarchical, and/or relative-difficulty relationships between lower- and higher-order skills. In an embodiment, the joint probability of the higher-order mastery profile o and the lower-order mastery profile m conditional on the data from the different products Y can be expressed as:

P(o,m|Y)∝P(Y|m)P(m|o)P(o)

According to embodiments, a Bayesian framework provides flexibility in combining the above approaches and tailoring them to the specific set of skills and hierarchical construct relationships at hand. The result of the proficiency aggregation engine is an aggregated proficiency that can be represented in the longitudinal learner profile and subsequently used in the recommendation, visualization, growth, and prediction engines.

According to embodiments, the longitudinal skills profile is a record that stores and tracks changes over time in each student's skill-based and aggregate proficiency estimates (which come, respectively, from the universal skill mastery engine 102 and the proficiency aggregation engine 103) by storing those estimates periodically (e.g., weekly). Advantageously, the generated longitudinal skills profile can be stored in a suitable computer-readable data store (e.g., a database).

According to embodiments, the profile can hold additional non-proficiency information about students such as interests, goals, and demographic information, which can be used as contextual information in the recommendation engine 104, the visualization engine 105, the growth engine 106, and the prediction engine 107.

In an embodiment, as shown in FIG. 1, the recommendation engine 104 identifies one or more skills for a student to work on based on the student's longitudinal skills profile as well as passed-in constraints. In an embodiment, for each student, the recommendation engine 104 uses the passed-in constraints to identify a “target set” of skills the recommendation should apply to (e.g., all skills, a single domain, a single standard, the skills covered in the current lesson, etc.). Based on the longitudinal skills profile, the recommendation engine 104 identifies skills in the target set for which a student has not yet reached a target level (e.g., any skills that the student has not yet “mastered”).

In an embodiment, the recommendation engine 104 delivers recommendations of skills to work on and a type of work (e.g., remediation, additional practice, or extension, as well as whether the work should be student- or instructor-driven) to do on those skills according to the following logic: if there are any unmastered skills in the target set, the recommendation engine 104 uses passed-in constraints as well as proficiency on prerequisite and related skills to recommend remediation or additional practice on unmastered skills or material for prerequisite skills; or if there are no unmastered skills in the target set, the recommendation engine 104 uses passed-in constraints as well as proficiency on postrequisite and related skills to recommend extension material on target-set skills or material for postrequisite skills.

In an embodiment, the recommendation engine 104 identifies appropriate instructor- and/or student-facing instructional assets, given a set of constraints (e.g., one or more of skills supported by the asset, current student or group proficiency in those skills, estimated difficulty/complexity of the asset, expected duration of assignment or presentation of the asset, etc.). For each student receiving one or more recommendations, the recommendation engine 104 analyses the one or more skills for that student to work on and the type of work for the student to perform relating to those skills. For each targeted skill, the recommendation engine 104 can identify recommendable assets based on mapping of product resources to that skill in the skills ontology and type of resource (remediation, practice, extension). In an embodiment, the recommendation engine 104 selects from among recommendable assets based on passed-in constraints (e.g., difficulty of assignment relative to estimated student proficiency, desired duration of assignment, whether assignment includes assessment, etc.). According to embodiments, the recommendation engine 104 generates an output that includes references to the selected assets (e.g., an output that can be provided to a student, a teacher, etc. via one or more of the product platforms).

According to embodiments, the visualization engine 105 renders charts, plots, graphs, and/or other data visualizations of various aspects of student proficiency and progress. In an embodiment, the data visualizations generated by the visualization engine can be displayed to a user (e.g., a teacher, administrator, student, or parent) via one or more graphical user interfaces associated with the proficiency profile management and recommendation system 100.

In an embodiment, the hierarchical chart type known as a sunburst chart provides a graphical representation of an ontology comprising Disciplines (e.g., Mathematics), Domains (e.g., Expressions & Equations), Standards (e.g., “Write, read, and evaluate expressions in which letters stand for numbers”), and Skills (e.g., “Evaluate algebraic expressions at specific values of their variables”).

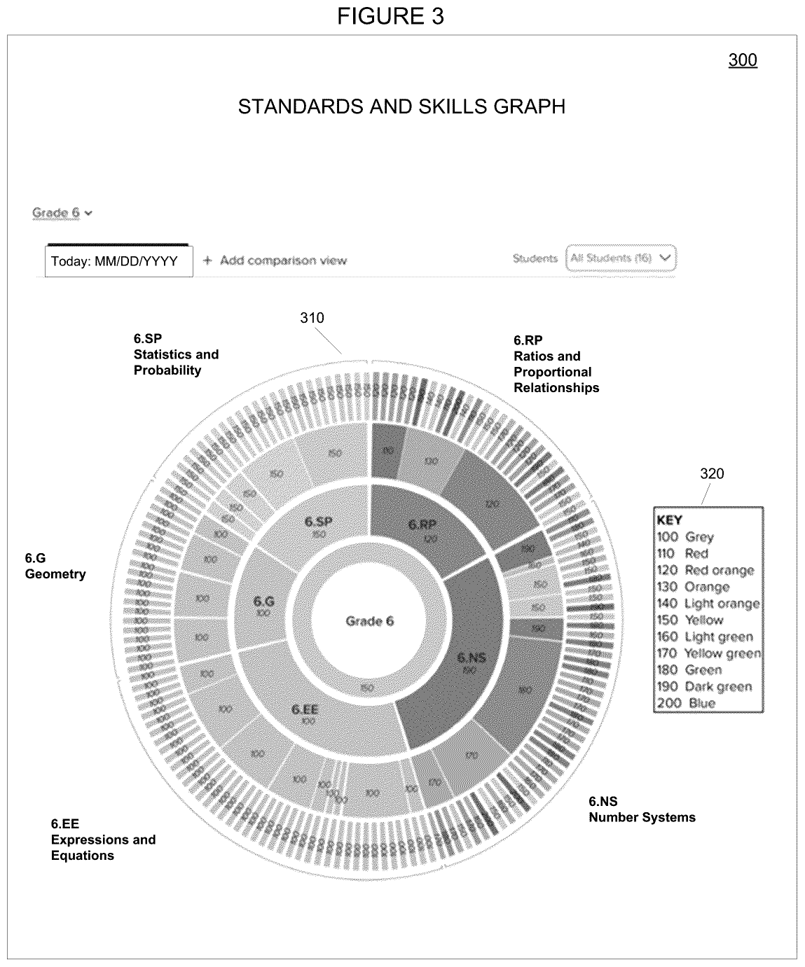

FIG. 3 illustrates an example interface displaying an example sunburst chart or graph 310 representing an example ontology including various categories or disciplines that is generated by the visualization engine 105. As illustrated, the graph 310 includes a set of domains corresponding to a particular grade level (e.g., Grade 6). As shown, the chart includes the domains of Statistics and Probability for Grade 6 (denoted as “6. SP”), Ratios and Proportional Relationships for Grade 6 (denoted as “6.RP”), Geometry for Grade 6 (denoted as “6.G”), Expressions and Equations for Grade 6 (denoted as “6.EE”), and Number Systems for Grade 6 (denoted as “6.NS”).

As illustrated, the interface of FIG. 3 includes a sunburst chart with four concentric rings, the innermost of which represents overall proficiency in the academic discipline relative to the grade level in the center of the chart, followed by proficiency in each domain of the subject (e.g., Geometry), then proficiency in each standard of each domain, and finally (in the outermost ring) proficiency in each skill in each standard. In the chart shown in FIG. 3, estimated proficiency is represented by color codes (e.g., 100 (Grey), 110 (Red), 120 (Red orange), 130 (Orange), 140 (Light orange), 150 (Yellow), 160 (Light Green), 170 (Yellow green), 180 (Green), 190 (Dark Green), and 200 (Blue)). In an embodiment, for the innermost two rings, the color codes represent a spectrum from a lowest level of proficiency represented by 110 (Red) to a highest level of proficiency represented by 200 (Blue), where 100 (Gray) represents insufficient data for an estimate. In an embodiment, for the outermost two rings, the color codes represent a scale corresponding to a likelihood or probability of mastery of a standard/skill, where 110 (Red) represents a very low likelihood of mastery and 200 (Blue) represents a very high likelihood of mastery of a standard/skill (with 100 (Gray) representing insufficient data for an estimate).

With reference to FIG. 1, in an embodiment, the growth engine 106 estimates changes in student proficiency on measured skills between two time points. In an embodiment, the growth engine 106 uses the longitudinal skills profile to infer change in stored proficiency estimates between time points, as well as the uncertainty associated with that growth, based on skill proficiency estimates and the uncertainty of those estimates due to the amount of data that went into the estimate and the signal quality of those data.

In an embodiment, the prediction engine 107 estimates future student proficiency and performance on benchmark-type tests based on prior measurements of student proficiency. According to embodiments, the prediction engine 107 is initialized by collecting a representative sample of students' longitudinal proficiency profiles, standardized test data, and additional relevant information about students (e.g., demographic and/or behavioral data). The collected data are used to create a prediction algorithm to predict future proficiency as well as performance on standardized tests. Next, for each student, the prediction engine 107 predicts future proficiency and performance on standardized tests based on the created prediction algorithm.

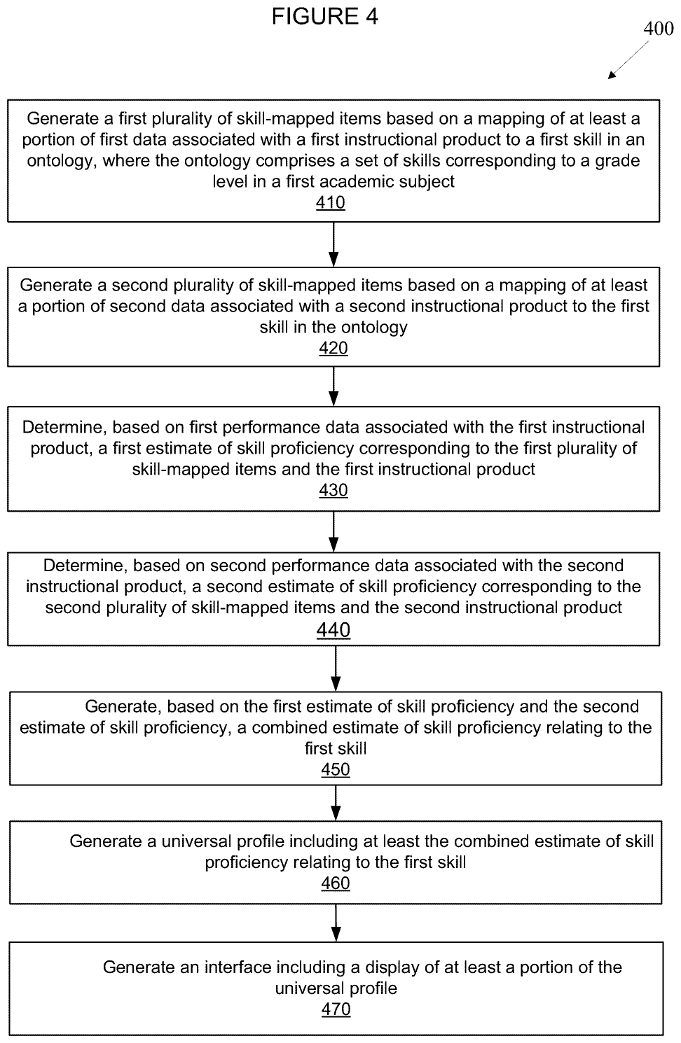

FIG. 4 illustrates a flow diagram of an example method 400 in accordance with an implementation of the disclosure. In one implementation, processing logic of the proficiency management and recommendation system 100 may perform method 400 to generate and display a universal proficiency profile based on data associated with multiple different instructional products or platforms. The method 400 may be performed by processing logic that may comprise hardware (circuitry, dedicated logic, etc.), software (such as is run on a general-purpose computer system or a dedicated machine), or a combination of both. Alternatively, in some other implementations, one or more processors of the computer device executing the method may perform routines, subroutines, or operations to perform method 400 and each of its individual functions. It should be noted that blocks of method 400 depicted in FIG. 4 can be performed simultaneously or in a different order than that depicted.

Referring to FIG. 4, at block 410, processing logic (e.g., processing logic of the proficiency management and recommendation system 100) generates a first plurality of skill-mapped items (e.g., a first set of multiple skill-mapped items) based on a mapping of at least a portion of first data associated with a first instructional product to a first skill in an ontology, where the ontology includes a set of skills corresponding to a grade level in a first academic subject (e.g., mathematics, English, history, etc.). At block 420, the processing logic generate a second plurality of skill-mapped items (e.g., a second set of multiple skill-mapped items) based on a mapping of at least a portion of second data associated with a second instructional product to the first skill in the ontology. According to embodiments, the processing logic advantageously collects the first data from the first instructional product (e.g., Product Platform 1 in FIG. 1) and the second data from the second instructional product (e.g., Product Platform N in FIG. 1).

At block 430, the processing logic determines, based on first performance data associated with the first instructional product, a first estimate of skill proficiency corresponding to the first plurality of skill-mapped items and the first instructional product. At block 440, the processing logic determines, based on second performance data associated with the second instructional product, a second estimate of skill proficiency corresponding to the second plurality of skill-mapped items and the second instructional product.

At block 450, the processing logic generates, based on the first estimate of skill proficiency and the second estimate of skill proficiency, a combined estimate of skill proficiency relating to at least the first skill. At block 460, the processing logic generates a universal profile including at least the combined estimate of skill proficiency relating to the first skill. At block 470, the processing logic generates an interface (e.g., a graphical user interface) including a display of at least a portion of the universal profile.

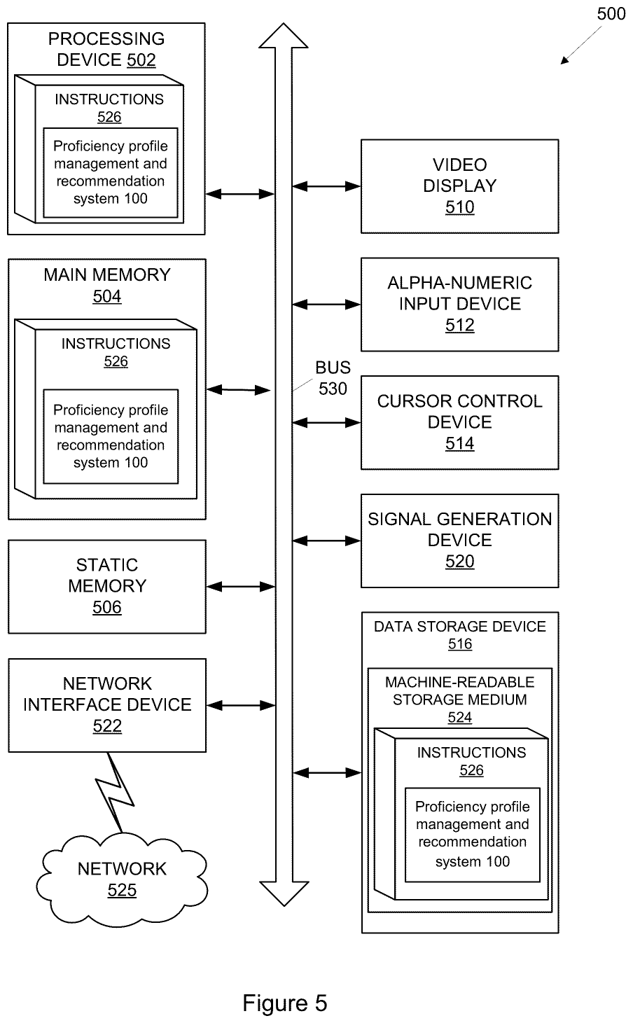

FIG. 5 illustrates an example computer system 500 operating in accordance with some embodiments of the disclosure. In FIG. 5, a diagrammatic representation of a machine is shown in the exemplary form of the computer system 500 within which a set of instructions, for causing the machine to perform any one or more of the methodologies discussed herein, may be executed. In alternative embodiments, the machine 500 may be connected (e.g., networked) to other machines in a local area network (LAN), an intranet, an extranet, or the Internet. The machine 500 may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, a switch or a bridge, or any machine capable of executing a set of instructions (sequential or otherwise) that specify actions to be taken by that machine 500. Further, while only a single machine is illustrated, the term “machine” shall also be taken to include any collection of machines that individually or jointly execute a set (or multiple sets) of instructions to perform any one or more of the methodologies discussed herein.

The example computer system 500 may comprise a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 516), which may communicate with each other via a bus 530.

Processing device 502 represents one or more general-purpose processing devices such as a microprocessor, central processing unit, or the like. More particularly, the processing device may be a complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute a proficiency profile and recommendation system for performing the operations and steps discussed herein. For example, the processing device 502 may be configured to execute instructions implementing the processes and methods described herein, for supporting a proficiency profile management and recommendation system, in accordance with one or more aspects of the disclosure.

Example computer system 500 may further comprise a network interface device 522 that may be communicatively coupled to a network 525. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 520 (e.g., a speaker).

Data storage device 516 may include a computer-readable storage medium (or more specifically a non-transitory computer-readable storage medium) 524 on which is stored one or more sets of executable instructions 526 of the proficiency profile management and recommendation system 100. In accordance with one or more aspects of the disclosure, executable instructions 526 may comprise executable instructions encoding various functions of the proficiency profile and recommendation system in accordance with one or more aspects of the disclosure.

Executable instructions 526 may also reside, completely or at least partially, within main memory 504 and/or within processing device 502 during execution thereof by example computer system 500, main memory 504 and processing device 502 also constituting computer-readable storage media. Executable instructions 526 may further be transmitted or received over a network via network interface device 522.

While computer-readable storage medium 524 is shown as a single medium, the term “computer-readable storage medium” should be taken to include a single medium or multiple media. The term “computer-readable storage medium” shall also be taken to include any medium that is capable of storing or encoding a set of instructions for execution by the machine that causes the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in those arts. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “analyzing,” “selecting,” “receiving,” “presenting,” “generating,” “deriving,” “providing” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

Examples of the disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the disclosure is not limited to any particular programming language. It will be appreciated that a variety of programming languages may be used to implement the teachings of the disclosure.

It is to be understood that the above description is intended to be illustrative, and not restrictive. Many other embodiment examples will be apparent to those of skill in the art upon reading and understanding the above description. Although the disclosure describes specific examples, it will be recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
generating a first plurality of skill-mapped items based on a mapping of at least a portion of first data associated with a first instructional product to a first skill in an ontology, wherein the ontology comprises a set of skills corresponding to a grade level in a first academic subject;
generating a second plurality of skill-mapped items based on a mapping of at least a portion of second data associated with a second instructional product to the first skill in the ontology;
determining, based on first performance data associated with the first instructional product, a first estimate of skill proficiency corresponding to the first plurality of skill-mapped items and the first instructional product;
determining, based on second performance data associated with the second instructional product, a second estimate of skill proficiency corresponding to the second plurality of skill-mapped items and the second instructional product;
generating, based on the first estimate of skill proficiency and the second estimate of skill proficiency, a combined estimate of skill proficiency relating to the first skill;
generating a universal profile comprising at least the combined estimate of skill proficiency relating to the first skill; and
generating an interface comprising a display of at least a portion of the universal profile.

2. The method of claim 1, wherein the display of the at least the portion of the universal profile comprises a description of a proficiency associated with the first skill.

3. The method of claim 1, further comprising generating, based on the universal profile, a recommendation comprising at least one of a first skill-mapped assignment associated with the first instructional product or a second skill-mapped assignment associated with the second instructional product.

4. The method of claim 1, further comprising monitoring a growth metric associated with the first skill over a time period.

5. The method of claim 1, further comprising generating a first prediction associated with performance corresponding to the first skill.

6. The method of claim 1, further comprising generating an update to the combined estimate of skill proficiency relating to the first skill based at least in part on updated first data and updated second data collected over a period of time.

7. The method of claim 6, wherein the updated first data and the updated second data are assigned a weighting based on one or more of an amount of time passed or a signal strength corresponding to the first instructional product or the second instructional product.

8. A system comprising:
a memory to store instructions; and
a processing device, operatively coupled to the memory, to execute the instructions to perform operations comprising:
generating a first plurality of skill-mapped items based on a mapping of at least a portion of first data associated with a first instructional product to a first skill in an ontology, wherein the ontology comprises a set of skills corresponding to a grade level in a first academic subject;
generating a second plurality of skill-mapped items based on a mapping of at least a portion of second data associated with a second instructional product to the first skill in the ontology;
determining, based on first performance data associated with the first instructional product, a first estimate of skill proficiency corresponding to the first plurality of skill-mapped items and the first instructional product;
determining, based on second performance data associated with the second instructional product, a second estimate of skill proficiency corresponding to the second plurality of skill-mapped items and the second instructional product;
generating, based on the first estimate of skill proficiency and the second estimate of skill proficiency, a combined estimate of skill proficiency relating to the first skill;
generating a universal profile comprising at least the combined estimate of skill proficiency relating to the first skill; and
generating an interface comprising a display of at least a portion of the universal profile.

9. The system of claim 8, wherein the display of the at least the portion of the universal profile comprises a description of a proficiency associated with the first skill.

10. The system of claim 8, the operations further comprising generating, based on the universal profile, a recommendation comprising at least one of a first skill-mapped assignment associated with the first instructional product or a second skill-mapped assignment associated with the second instructional product.

11. The system of claim 8, the operations further comprising monitoring a growth metric associated with the first skill over a time period.

12. The system of claim 8, the operations further comprising generating a first prediction associated with performance corresponding to the first skill.

13. The system of claim 8, the operations further comprising generating an update to the combined estimate of skill proficiency relating to the first skill based at least in part on updated first data and updated second data collected over a period of time.

14. The system of claim 13, wherein the updated first data and the updated second data are assigned a weighting based on one or more of an amount of time passed or a signal strength corresponding to the first instructional product or the second instructional product.

15. A non-transitory computer-readable storage medium having instructions that, when executed by a processing device, cause the processing device to perform operations comprising:
generating a first plurality of skill-mapped items based on a mapping of at least a portion of first data associated with a first instructional product to a first skill in an ontology, wherein the ontology comprises a set of skills corresponding to a grade level in a first academic subject;
generating a second plurality of skill-mapped items based on a mapping of at least a portion of second data associated with a second instructional product to the first skill in the ontology;
determining, based on first performance data associated with the first instructional product, a first estimate of skill proficiency corresponding to the first plurality of skill-mapped items and the first instructional product;
determining, based on second performance data associated with the second instructional product, a second estimate of skill proficiency corresponding to the second plurality of skill-mapped items and the second instructional product;
generating, based on the first estimate of skill proficiency and the second estimate of skill proficiency, a combined estimate of skill proficiency relating to the first skill;
generating a universal profile comprising at least the combined estimate of skill proficiency relating to the first skill; and
generating an interface comprising a display of at least a portion of the universal profile.

16. The non-transitory computer-readable storage medium of claim 15, wherein the display of the at least the portion of the universal profile comprises a description of a proficiency associated with the first skill.

17. The non-transitory computer-readable storage medium of claim 15, the operations further comprising generating, based on the universal profile, a recommendation comprising at least one of a first skill-mapped assignment associated with the first instructional product or a second skill-mapped assignment associated with the second instructional product.

18. The non-transitory computer-readable storage medium of claim 15, the operations further comprising monitoring a growth metric associated with the first skill over a time period.

19. The non-transitory computer-readable storage medium of claim 15, the operations further comprising generating a first prediction associated with performance corresponding to the first skill.

20. The non-transitory computer-readable storage medium of claim 15, the operations further comprising generating an update to the combined estimate of skill proficiency relating to the first skill based at least in part on updated first data and updated second data collected over a period of time, wherein the updated first data and the updated second data are assigned a weighting based on one or more of an amount of time passed or a signal strength corresponding to the first instructional product or the second instructional product.
